(19) United States
(12) Patent Application Publication
(10) Pub. No.: US 2017/0098946 A1
(43) Pub. Date: Apr. 6, 2017

(54) CELL PHONE ENERGY EXCHANGE DEVICE/ SYSTEM AND METHOD

(71) Applicant: Bernard Walls, Manassas, VA (US)

(72) Inventor: Bernard Walls, Manassas, VA (US)

(21) Appl. No.: 15/386,386

(22) Filed: Dec. 21, 2016

Related U.S. Application Data
(63) Continuation-in-part of application No. 14/121,550, filed on Sep. 18, 2014.

(51) Int. Cl. H02J 7/00; H01R 24/60

(52) U.S. Cl. CPC H02J 7/0044; H02J 7/0052; H01R 24/60; H02J 2007/0062

(57) ABSTRACT

A cell phone energy exchange system and method includes a plurality of USB micro to smartphone connectors and a cell phone energy exchange device having a main enclosure including a power on/off switch, at least one device A input/output combination connector/cord, at least one device B input/output combination connector/cord, a rear storage compartment, a device charger port, an electronic display, a power transfer system, control circuitry, an internal power source, at least one multi-function button, at least one up arrow button, at least one down arrow button, at least one right arrow button, and at least one left arrow button. The cell phone energy exchange system and method is useful for charging one smartphone from a second smartphone to a preset level in preset increments.

### CROSS-REFERENCE TO RELATED APPLICATION

The present application is related to and claims priority to pending U.S. patent application Ser. No. 14/121,550 filed Sep. 18, 2014 which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

1. Field of the Invention

The present invention relates generally to the field of charge circuits art and more specifically relates to circuit arrangements for charging or depolarizing batteries or for supplying loads.

2. Description of Related Art

Cell phone users often find themselves in need of charging a phone when utility power is not present. Many rechargeable power source options exist however often times the only available power source is another cellular phone. Although USB-OTG (Universal Serial Bit On-the-Go) power cable solutions exist for charging one smartphone from another, these lack several options including a pre-programmed charge increment, a pre-programmed charge amount, and the ability to charge at the USB maximum rate of 3 amps. A better solution is needed.

U.S. Pat. No. 9,401,609B2 to Shapley relates to a portable power transfer device. The described portable power transfer device includes a portable transfer device that has input connectors and output connectors which can be used to transfer power from a first electronic device to a second electronic device. The connectors are housed in a main enclosure. An internal power source is also housed in the main enclosure. The second electronic device can be charged through an output connector or a USB cable connected to the auxiliary USB port by draining power from the first electronic device or from the internal power source. A voltage regulation circuit is electrically connected between the input connectors and the output connectors, as well as between the auxiliary port and the input connectors. The voltage regulation circuit ensures a desirable output voltage.

In view of the foregoing disadvantages inherent in the known charge circuits only adapted for charging from various sources art, the present disclosure provides a novel cell phone energy exchange system and method. The general purpose of the present disclosure, which will be described subsequently in greater detail, is to provide a cell phone energy exchange system and method.

A cell phone energy exchange system and method is disclosed herein. The cell phone energy exchange system and method includes a cell phone energy exchange system comprising a plurality of USB micro to smartphone connectors and a cell phone energy exchange device having a main enclosure including a power on/off switch, at least one device A input/output combination connector/cord, at least one device B input/output combination connector/cord, a rear storage compartment, a device charger port, an electronic display, a power transfer system, control circuitry, an internal power source, at least one multi-function button, at least one up arrow button, at least one down arrow button, at least one right arrow button, and at least one left arrow button. The cell phone energy exchange device acts as a means by which to draw power from device A to charge the battery of device B.

The cell phone energy exchange device has at least one device A input/output combination connector/cord having a device A cord and a device A input/output connector. The cell phone energy exchange device has at least one device B input/output combination connector/cord having a device B cord and a device B input/output connector. The main enclosure has a rear storage compartment including a compartment door and a recessed compartment cavity for storing the plurality of USB micro to smartphone connectors and at least two input/output connector storage ports for storing device A input/output connector and device B input/output connector in the main enclosure when not in use. The power transfer system has a battery charging circuit and a voltage regulation circuit. The control circuitry has control logic, a display driver, and at least two USB-OTG ports. The at least one up arrow button has a graphic indicator of an arrow pointing up. The at least one down arrow button has a graphic indicator of an arrow pointing down. The at least one right arrow button has a graphic indicator of an arrow pointing right. The at least one left arrow button has a graphic indicator of an arrow pointing left.

According to another embodiment, a cell phone energy exchange system and method is also disclosed herein wherein the internal power source is a battery. The control logic delegates device A as USB master device and device B as USB slave device. The voltage regulator circuit is capable of powering at least one device A input/output combination connector/cord and at least one device B input/output combination connector/cord simultaneously from the device charger port. The voltage regulator circuit is capable of driving a USB rated voltage of 5 volts and USB maximum rated current of 3 amps per the at least two USB-OTG ports. The at least one up arrow button increases charge level settings in increments of 5% and the at least one down arrow button decreases charge level settings in increments of 5%.

The at least one right arrow button switches the electronic display indications to the charge levels of device B and the at least one left arrow button switches the electronic display indications to the charge levels of device A on the electronic display of the cell phone energy exchange device. The electronic display indicates the amount of total charge transfer setting, the control circuitry drives the electronic display of device A through USB signaling via at least one device A input/output combination connector/cord, and the control circuitry drives electronic display of the device B through USB signaling via at least one device B input/output combination connector/cord. The control circuitry drives the electronic display of device A in a manner that displays ‘BEFORE’ and ‘AFTER’ text along with associated charge levels respectively and the control circuitry drives the electronic display of device B in a manner that displays ‘BEFORE’ and ‘AFTER’ text along with associated charge levels respectively. The plurality of USB micro to smartphone connectors includes a USB micro to smartphone adapter connector. The plurality of USB micro to smartphone connectors includes a USB micro to Samsung platform cell phone adapter connector.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a cell phone energy exchange system and method, constructed and operative according to the teachings of the present disclosure.

FIG. 1 is a perspective view of the cell phone energy exchange system and method during an ‘in-use’ condition, according to an embodiment of the disclosure.

FIG. 2 is a perspective three dimensional view of the cell phone energy exchange system and method of FIG. 1, according to an embodiment of the present disclosure.

FIG. 3 is a perspective three dimensional view of the cell phone energy exchange system and method of FIG. 1, according to an embodiment of the present disclosure.

FIG. 4 is a schematic view of the cell phone energy exchange system and method of FIG. 1, according to an embodiment of the present disclosure.

FIG. 5 is a flow diagram illustrating a method of use for the cell phone energy exchange system and method, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to charge circuits and more particularly to circuit arrangements for charging or depolarizing batteries or for supplying loads as used to improve the method by which one cell phone charges a second cell phone.

Generally speaking, the cell phone energy exchange system and method primarily provides a method by which to charge one cell phone from another while controlling charge increments and charge levels in each phone. Secondary benefits include the ability to charge one or two phones rapidly from an external power source or the cell phone energy exchange device's internal power source.

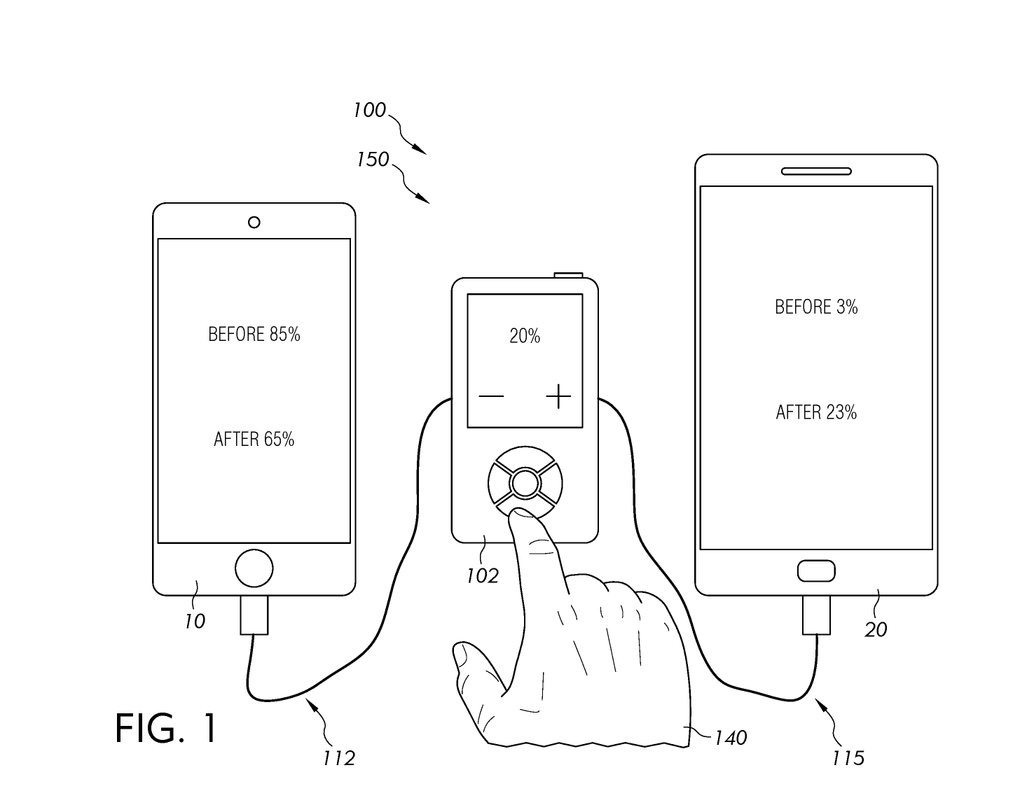

Referring now more specifically to the drawings by numerals of reference, there is shown in FIGS. 1-4, various views of a cell phone energy exchange system and method 100. FIG. 1 shows a cell phone energy exchange device 102 during an ‘in-use’ condition 150, according to an embodiment of the present disclosure. Here, the cell phone energy exchange system and method 100 may be beneficial for use by a user 140 to use the charge in device A 10 to charge device B 20. As illustrated, the cell phone energy exchange system and method 100 may include a cell phone energy exchange device 102 at least one device A input/output combination connector/cord 112, at least one device B input/output combination connector/cord 115 as a means by which to draw power from device A 10 to charge device B 20.

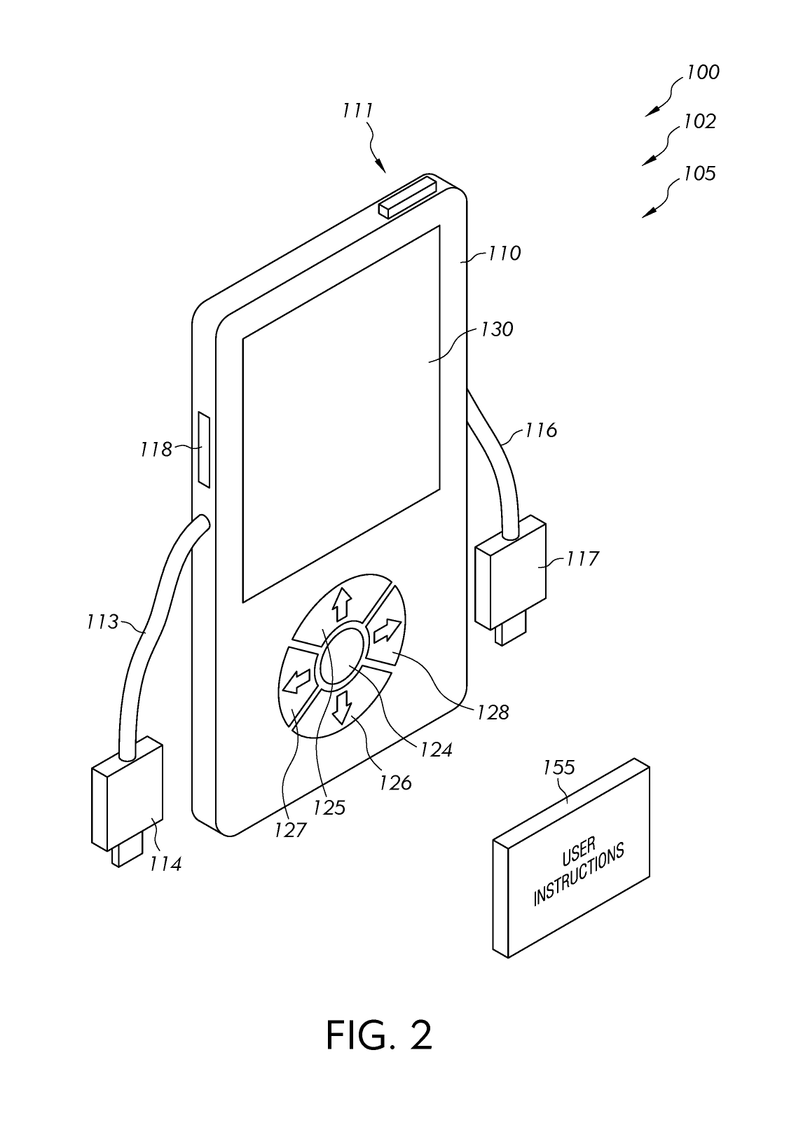

FIG. 2 shows the cell phone energy exchange system and method 100 of FIG. 1, according to an embodiment of the present disclosure. As illustrated, the cell phone energy exchange system and method 100 may include a cell phone energy exchange device 102 having a main enclosure 110 including a power on/off switch 111, at least one device A input/output combination connector/cord 112, at least one device B input/output combination connector/cord 115, an electronic display 130, at least one multi-function button 124, at least one up arrow button 127, at least one down arrow button 126, at least one right arrow button 128, and at least one left arrow button 125. The at least one device A input/output combination connector/cord 112, has a device A cord 113 and device A input/output connector 114. The at least one device B input/output combination connector/cord 115 has a device B cord 116 and a device B input/output connector 117. In the preferred embodiment at least one device A cord 113 is nine inches in length and at least one device B cord 116 is nine inches in length.

The main enclosure 110 has at least two input/output connector storage ports 118 for storing device A input/output connector 114 and device B input/output connector 117 in the main enclosure 110 when not in use.

According to one embodiment, the cell phone energy exchange system and method 100 may be arranged as a kit 105. In particular, the cell phone energy exchange system and method 100 may further include a set of instructions 155. The instructions 155 may detail functional relationships in relation to the structure of the cell phone energy exchange system and method 100 (such that the cell phone energy exchange system and method 100 can be used, maintained, or the like, in a preferred manner).

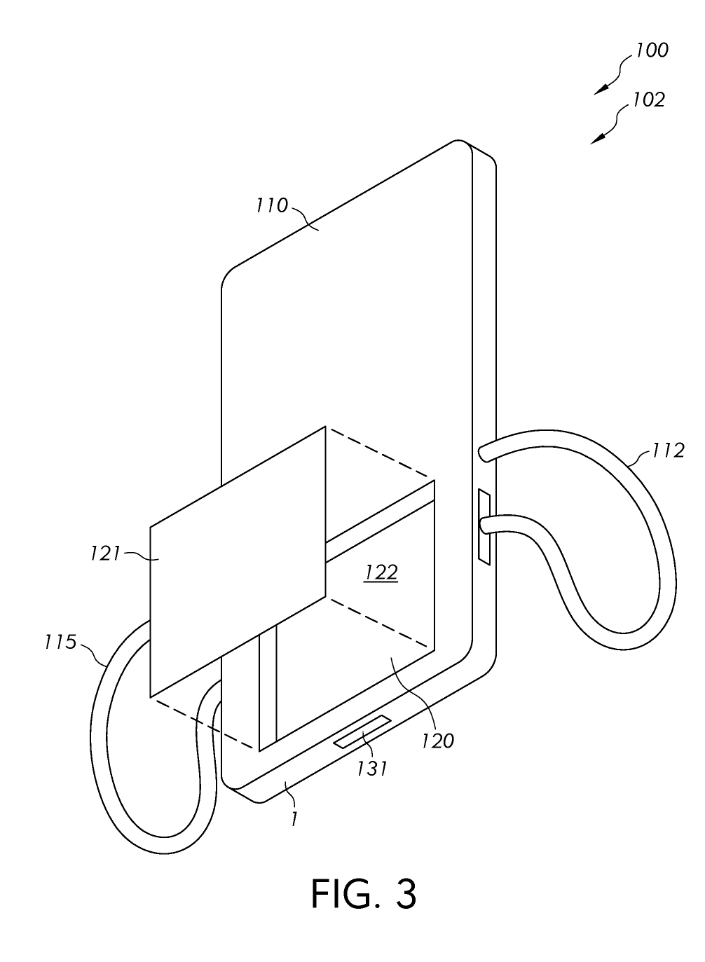

FIG. 3 is a perspective view of the cell phone energy exchange system and method 100 of FIG. 1, according to an embodiment of the present disclosure. shows the cell phone energy exchange system and method of FIG. 1, according to an embodiment of the present disclosure. As illustrated, the cell phone energy exchange system and method 100 may include a cell phone energy exchange device 102 having a main enclosure 110 including at least one device A input/output combination connector/cord 112, at least one device B input/output combination connector/cord 115, a device charger port 131 and a rear storage compartment 120 including a compartment door 121 and a recessed compartment cavity 122.

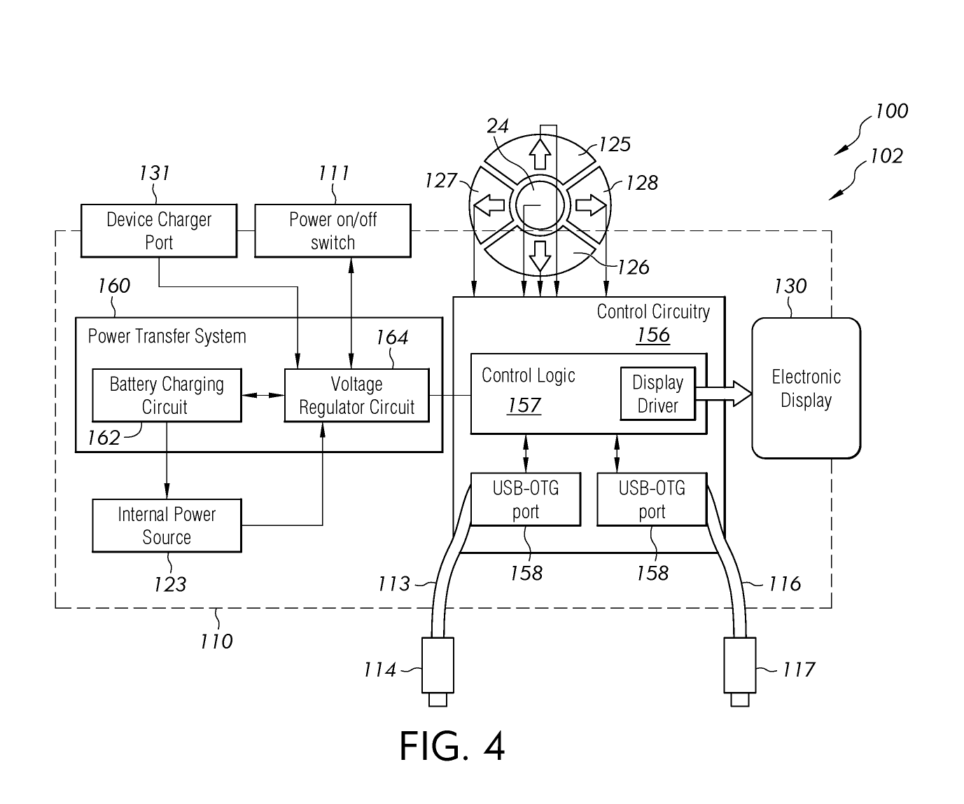

FIG. 4 is a schematic view of the cell phone energy exchange system and method 100 of FIG. 1, according to an embodiment of the present disclosure. As illustrated, the cell phone energy exchange system and method 100 may include a cell phone energy exchange device 102 having a main enclosure including a power on/off switch 111, at least one device A input/output combination connector/cord 112, at least one device B input/output combination connector/cord 115, and an electronic display 130. The at least one device A input/output combination connector/cord 112, has a device A cord 113 and device A input/output connector 114. The at least one device B input/output combination connector/cord 115 has a device B cord 116 and a device B input/output connector 117. The cell phone energy exchange system and method 100 may also include power transfer system 160 having battery charger circuit 162 and voltage regulator circuit 164 that work together in functional combination to charge internal power source 123 and create a USB voltage level of 5 VDC and 6 kamps maximum current level respectively. Voltage regulator circuit 164 is powered by several sources using diode ORing from the device charger port 131, the internal power source 120, and/or device A 10 via at least one device A input/output combination connector/cord 112 by way of control circuitry 156. Voltage regulator circuit 164 provides at least 6 amps of current in order for a maximum USB current level of 3 amps to each of the at least two USB-OTG ports 158.

According to this embodiment, a cell phone energy exchange system and method 100 is also disclosed herein with schematic representation illustrating electrical connections within the circuitry shown in FIG. 4. This preferred embodiment illustrates the cell phone energy exchange system and method 100 wherein the internal power source 123 is a battery. The cell phone energy exchange system 100 has control logic 157 that delegates device A 10 as USB master device for providing charge power and device B 20 as USB slave device for receiving charge power using USB-OTG charging methods. The cell phone energy exchange system and method 100 has voltage regulator circuit 164 that is capable of powering at least one device A input/output combination connector/cord 112 and at least one device B input/output combination connector/cord 115 simultaneously from the device charger port 131 at a USB rated voltage of 5 volts and USB maximum rated current of 3 amps per the at least two USB-OTG ports 158.

The at least two USB-OTG ports 158 in turn charges device A 10 through the at least one device A input/output combination connector/cord 112 and device B 20 through the at least one device B input/output combination connector/cord 115. The at least one up arrow button 125 increases charge level settings in increments of 5% and the at least one down arrow button 126 decreases charge level settings in increments of 5%. The at least one right arrow button 128 switches electronic display 130 indications to the charge levels of device B 20 and the at least one left arrow button 127 switches electronic display 130 indications to the charge levels of device A 10. The electronic display 130 indicates the amount of total charge transfer setting while the control circuitry 156 drives the electronic display of device A 10 through USB signaling via at least one device A input/output combination connector/cord 112, and control circuitry 130 drives the electronic display of the device B 20 through USB signaling via at least one device B input/output combination connector/cord 115. The control circuitry 156 drives the electronic display of device A 10 in a manner that displays ‘BEFORE’ and ‘AFTER’ text along with associated charge levels respectively and the control circuitry 156 drives the electronic display of device B 20 in a manner that displays ‘BEFORE’ and ‘AFTER’ text along with associated charge levels respectively.

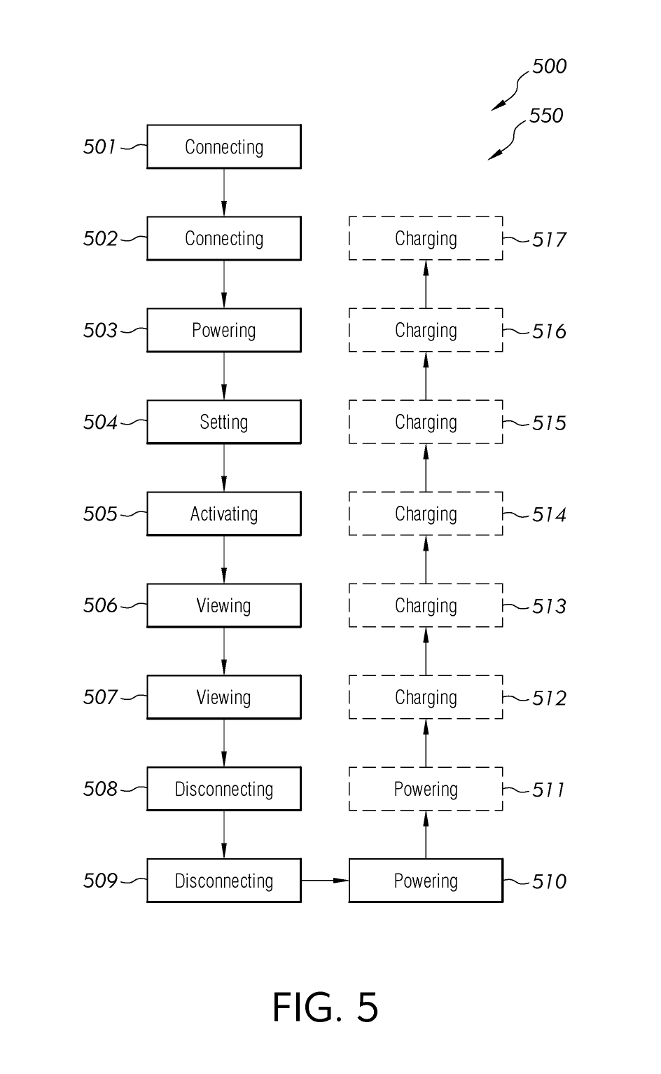

FIG. 5 is a flow diagram 550 illustrating a method of charging device B 20 from device a 10 with a cell phone energy exchange system and method 100, according to an embodiment of the present disclosure. In particular, the method for a cell phone energy exchange system and method 500 may include one or more components or features of the cell phone energy exchange system and method 100 as described above. As illustrated, the method for a cell phone energy exchange system and method 500 may include the steps of: step one 501, connecting a cell phone energy exchange device 102 by connecting a device A 10 to device A input/output connector 114; step two 502, connecting a cell phone energy exchange device 102 by connecting device B 20 to a device B input/output connector 117; step three 503, powering the cell phone energy exchange device 102 via the power on/off switch 111; step four 504, setting the charge level of a cell phone energy exchange device 102 with the at least one down arrow button 126 or at least one up arrow button 127; step five 505, activating the electronic display 130 via the at least one multi-function button 124; step six 506, viewing the charge transfer percentage setting on the electronic display 130; step seven 507, viewing the electronic display of device B 20 for proper charge level; step eight 508, disconnecting device B 20 when charge level is sufficient by having reached a preset level; step nine 509, disconnecting device A 10; step ten 510, powering off the a cell phone energy exchange device 102 via the power on/off switch 111; step eleven 511, powering the cell phone energy exchange device 102 via the device charger port 131; step twelve 512, charging the internal power storage source 123; step thirteen 513, charging device A 10 via the internal power source 123; step fourteen 514, charging device B 20 via the internal power storage source 123; step fifteen 515, charging device A 10 via the device charger port 131; step sixteen 516, charging device B 20 via the device charger port 131; and step seventeen 517, charging device A 10 and device B 20 simultaneously via the device charger port 131.

It should be noted that steps 511 through 517 are optional steps and may not be implemented in all cases. Optional steps of method of use 500 are illustrated using dotted lines in FIG. 5 so as to distinguish them from the other steps of method of use 500. It should also be noted that the steps described in the method of use 500 can be carried out in many different orders according to user preference. The use of “step of” should not be interpreted as “step for”, in the claims herein and is not intended to invoke the provisions of 35 U.S.C. §112(f). It should also be noted that, under appropriate circumstances, considering such issues as design preference, user preferences, marketing preferences, cost, structural requirements, available materials, technological advances, etc., other methods for the cell phone energy exchange system (e.g., different step orders within above-mentioned list, elimination or addition of certain steps, including or excluding certain maintenance steps, etc.), are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A cell phone energy exchange system and method, the cell phone energy exchange system comprising:
a plurality of USB micro to smartphone connectors;
a cell phone energy exchange device having;
a main enclosure including;
a power on/off switch;
at least one device A input/output combination connector/cord having;
a device A cord; and
a device A input/output connector;
at least one device B input/output combination connector/cord having;
a device B cord; and
a device B input/output connector;
at least two input/output connector storage ports;
a rear storage compartment including;
a compartment door and
a recessed compartment cavity;
a device charger port;
an electronic display;
a power transfer system having;
battery charging circuit and
a voltage regulation circuit;
control circuitry having;
control logic;
a display driver; and
at least two USB-OTG ports;
an internal power source;
at least one multi-function button;
at least one up arrow button having;
a graphic indicator of an arrow pointing up;
at least one down arrow button having;
a graphic indicator of an arrow pointing down;
at least one right arrow button having;
a graphic indicator of an arrow pointing right; and
at least one left arrow button having;
a graphic indicator of an arrow pointing left;
wherein said rear storage compartment, said compartment door, and said recessed compartment cavity work together in functional combination for storing connector port adapters;
wherein said control circuitry has an electrical connection for receiving signals from said at least one multi-function button; at least one up arrow button, said at least one down arrow button, said at least one right arrow button, and said at least one left arrow button;
wherein said control circuitry has a display driver;
wherein one of said at least two USB-OTG ports is electrically connected to at least one device A input/output combination connector/cord;
wherein another one of said at least two USB-OTG ports is electrically connected to at least one device B input/output combination connector/cord;
wherein said at least one device A cord is nine inches in length;
wherein said at least one device B cord is nine inches in length;
wherein said at least one device A input/output connector is a first USB micro connector;
wherein said at least one device B input/output connector is a second USB micro connector;
wherein said at least one device A input/output combination connector/cord is electrically connected to said at least one device B input/output combination connector/cord through said voltage regulation system in combination with said control circuitry;
wherein said device charger port is positioned into said main enclosure;
wherein said device charger port is electrically connected to said internal device power source through said battery charging circuit in combination with said voltage regulator circuit;
wherein said device charger port is electrically connected to said at least one device A input/output combination connector/cord through said voltage regulation system;
wherein said at least one device A input/output combination connector/cord is electrically connected to said internal device power source through said voltage regulator circuit in combination with said control circuitry;
wherein said device charger port is electrically connected to said at least one device B input/output combination connector/cord through said voltage regulation system in combination with said control circuitry;
wherein said at least one device B input/output combination connector/cord is electrically connected to said internal device power source through said voltage regulator circuit in combination with said control circuitry; and
wherein said a cell phone energy exchange device provides a means by which to draw power from said device A to charge the battery of said device B.

2. The cell phone energy exchange system and method of claim 1, wherein said internal power source is a battery.

3. The cell phone energy exchange system and method of claim 1, wherein said control logic delegates device A as USB master device and device B as USB slave device.

4. The cell phone energy exchange system and method of claim 1, wherein said voltage regulator circuit is capable of powering said at least one device A input/output combination connector/cord and said at and least one device B input/output combination connector/cord simultaneously from said device charger port.

5. The cell phone energy exchange system and method of claim 1, wherein said voltage regulator circuit is capable of driving a USB rated voltage of 5 volts and USB maximum rated current of 3 amps per said at least two USB-OTG ports.

6. The cell phone energy exchange system and method of claim 1, wherein said at least one up arrow button increases charge level settings in increments of 5%.

7. The cell phone energy exchange system and method of claim 1, wherein said at least one down arrow button decreases charge level settings in increments of 5%.

8. The cell phone energy exchange system and method of claim 7, wherein said at least one right arrow button switches display indications to a charge levels of device B.

9. The cell phone energy exchange system and method of claim 1, wherein said at least one left arrow button switches display indications to the charge levels of device A.

10. The cell phone energy exchange system and method of claim 7, wherein said display indicates said amount of total charge transfer setting.

11. The cell phone energy exchange system and method of claim 1, wherein said control circuitry drives display of said device A through USB signaling via said at least one device A input/output combination connector/cord.

12. The cell phone energy exchange system and method of claim 1, wherein said control circuitry drives display of said device B through USB signaling via said at least one device B input/output combination connector/cord.

13. The cell phone energy exchange system and method of claim 11, wherein said control circuitry drives display of said device A in a manner that displays ‘BEFORE’ and ‘AFTER’ text along with associated charge levels respectively.

14. The cell phone energy exchange system and method of claim 12, wherein said control circuitry drives display of said device B in a manner that displays ‘BEFORE’ and ‘AFTER’ text along with associated charge levels respectively.

15. The cell phone energy exchange system and method of claim 1, wherein said plurality of USB micro to smartphone connectors includes a USB micro to smartphone adapter connector.

16. The cell phone energy exchange system and method of claim 1, wherein said plurality of USB micro to smartphone connectors includes a USB micro to a Samsung platform cell phone adapter connector.

17. A cell phone energy exchange system and method, the cell phone energy exchange system comprising:
a plurality of USB micro to smartphone connectors;
a cell phone energy exchange device having;
a main enclosure including;
a power on/off switch;
at least one device A input/output combination connector/cord having;
a device A cord and
a device A input/output connector;
at least one device B input/output combination connector/cord having;
a device B cord and
a device B input/output connector;
at least two input/output connector storage ports;
a rear storage compartment including;
a compartment door and
a recessed compartment cavity;
a device charger port;
an electronic display;
a power transfer system having;
a battery charging circuit and
a voltage regulation circuit;
control circuitry having;
control logic;
a display driver; and
at least two USB-OTG ports;
an internal power source;
at least one multi-function button comprising;
at least one up arrow button having;
a graphic indicator of an arrow-pointing-up;
at least one down arrow button having;
a graphic indicator of an arrow-pointing-down;
at least one right arrow button having;
a graphic indicator of an arrow-pointing-right; and
at least one left arrow button having;
a graphic indicator of an arrow pointing left;
wherein said rear storage compartment, said compartment door, and said recessed compartment cavity work together in functional combination for storing connector port adapters;
wherein said control circuitry has an electrical connection for receiving signals from said at least one multi-function button;
wherein said control circuitry has a display driver;
wherein one of said at least two USB-OTG ports is electrically connected to at least one device A input/output combination connector/cord;
wherein another one of said at least two USB-OTG ports is electrically connected to at least one device B input/output combination connector/cord;
wherein said at least one device A cord is nine inches in length;
wherein said at least one device B cord is nine inches in length;
wherein said at least one device A input/output connector is a first USB micro connector;
wherein said at least one device B input/output connector is a second USB micro connector;
wherein said at least one device A input/output combination connector/cord is electrically connected to said at least one device B input/output combination connector/cord through said voltage regulation system in combination with said control circuitry;
wherein said device charger port is positioned into said main enclosure;
wherein said device charger port is electrically connected to said internal device power source through said battery charging circuit in combination with said voltage regulator circuit;
wherein said device charger port is electrically connected to said at least one device A input/output combination connector/cord through said voltage regulation system;
wherein said at least one device A input/output combination connector/cord is electrically connected to said internal device power source through said voltage regulator circuit in combination with said control circuitry;
wherein said device charger port is electrically connected to said at least one device B input/output combination connector/cord through said voltage regulation system in combination with said control circuitry;
wherein said at least one device B input/output combination connector/cord is electrically connected to said internal device power source through said voltage regulator circuit in combination with said control circuitry;
wherein said a cell phone energy exchange device provides a means by which to draw power from said device A to charge the battery of said device B;
wherein said internal power source is a battery;
wherein said control logic delegates device A as USB master device and device B as USB slave device;
wherein said voltage regulator circuit is capable of powering said at least one device A input/output combination connector/cord and said at and least one device B input/output combination connector/cord simultaneously from said device charger port;
wherein said voltage regulator circuit is capable of driving a USB rated voltage of 5 volts and USB maximum rated current of 3 amps per said at least two USB-OTG ports;
wherein said at least one up arrow button increases charge level settings in increments of 5%;
wherein said at least one down arrow button decreases charge level settings in increments of 5%;
wherein said at least one right arrow button switches display indications to a charge levels of device B;
wherein said at least one left arrow button switches display indications to the charge levels of device A;
wherein said display indicates said amount of total charge transfer setting;
wherein said control circuitry drives display of said device A through USB signaling via said at least one device A input/output combination connector/cord;
wherein said control circuitry drives display of said device B through USB signaling via said at least one device B input/output combination connector/cord;
wherein said control circuitry drives display of said device A in a manner that displays ‘BEFORE’ and ‘AFTER’ text along with associated charge levels respectively;
wherein said control circuitry drives display of said device B in a manner that displays ‘BEFORE’ and ‘AFTER’ text along with associated charge levels respectively;
wherein said plurality of USB micro to smartphone connectors includes a USB micro to smartphone adapter connector; and
wherein said plurality of USB micro to smartphone connectors includes a USB micro to a Samsung platform smartphone adapter connector.

18. The cell phone energy exchange system and method of claim 17, further comprising set of instructions to form a kit.

19. A method of use for a cell phone energy exchange system and method, the method comprising the steps of:
connecting a device A to a device A input/output connector;
connecting a device B to a device B input/output connector;
powering a cell phone energy exchange via a power on/off switch;
setting a charge level using at least one up arrow button;
activating an electronic display via at least one multi-function button;
viewing an electronic display transfer percentage setting;
viewing the electronic display of device B for proper charge level;
disconnecting the device B when charge level is sufficient;
disconnecting the device A; and
powering off a cell phone energy exchange device via the power on/off switch.

20. The method of claim 19, further comprising the steps of:
powering the cell phone energy exchange device via the device charger port;
charging an internal power source;
charging the device A via the internal power source;
charging the device B via the internal power source;
charging the device A via the device charger port;
charging the device B via the device charger port; and
charging the devices A and B via the device charger port.
